(19) United States
(12) Patent Application Publication
(10) Pub. No.: US 2015/0295227 A1
(43) Pub. Date: Oct. 15, 2015

(54) SILICON AND GRAPHENE-INCORPORATED RECHARGEABLE LI-ION BATTERIES WITH ENHANCED ENERGY DELIVERY AND CYCLING LIFE BY USING SILECON AND GRAPHENE BASED ANODE FOR ENERGY STORAGE

(71) Applicants: Xin Zhao, New York, NY (US); Minjie Li, Taipei (TW); Yu-Ming Lin, New York, NY (US)

(72) Inventors: Xin Zhao, New York, NY (US); Minjie Li, Taipei (TW); Yu-Ming Lin, New York, NY (US)

(21) Appl. No.: 14/250,398

(22) Filed: Apr. 11, 2014

(51) Int. Cl. H01M 4/134; H01M 4/1395; H01M 4/04

(52) U.S. Cl. CPC H01M 4/134; H01M 4/0416; H01M 4/043; H01M 4/1395; H01M 2004/027

(57) ABSTRACT

A silicon graphene-incorporated rechargeable Li-ion battery with enhanced energy delivery and cycling life comprising a high-performance Si/graphene composite anode, a cathode film and electrolyte is disclosed. The anode and cathode are immersed in or partially immersed in the electrolyte; wherein the anode is formed of a mixture of carbon coated Si and graphene composite with a polymer binder and a conductive additive. A method for fabricating such Si and graphene-based anode comprises the steps synthesis of carbon coated Si particles by polymer encapsulation and carbonization; enveloping the coated Si particles in graphene by mechanical agitation; formulating the carbon coated Si and graphene with a polymer binder and conductive additive; depositing the mixture onto current collectors. The anode structure affords a combination of superior rate capability, cycling life and improved volumetric capacity.

### FIELD OF THE INVENTION

The present invention related to Li-ion batteries, and in particular to a silicon and graphene-incorporated rechargeable Li-ion battery with enhanced energy delivery and cycling life by employing a high-performance silicon and graphene composite anode.

### BACKGROUND OF THE INVENTION

Metallic and semi-metallic elements that undergo electrochemical alloying with lithium serve as alternative anode systems to radically boost the capacity and energy density of lithium-ion batteries. Amongst these silicon is of particular interest owing to its low lithium-update potential and the highest theoretical capacity. Derived from alloying reactions with lithium ions, silicon attains a gravimetric capacity beyond 3500 mAh/g and a volumetric capacity of 7 Ah/cm³ theoretically (referring to D. Larcher, S. Beattie, M.

Morcrette, K. Edström, J.-C. Jumas and J.-M. Tarascon, J. Mater. Chem., 2007, 17, 3759-3772; and M. N. Obrovac and L. Christensen, Electrochem. Solid-State Lett., 2004, 7, A93-A96.). However, the practical implementation of silicon in rechargeable batteries is severely handicapped by the limited intrinsic electrical conductivity and side reactions upon contacting with electrolyte. Moreover, the dramatic volumetric variation concomitanting with the alloying process results in mechanical pulverization of the active particles, and consequently loss of contact between the grains and current collectors. This gradually depletes the available electrolyte and disintegrates the electrode films, which greatly hinders the rate capability and cycling life of the electrodes (referring to C. K. Chan, H. Peng, G. Liu, K. McIlwrath, X. F. Zhang, R. A. Huggins and Y. Cui, Nat. Nanotech., 2008, 3, 31-35; and Y. Oumellal, N. Delpuech, D. Mazouzi, N. Dupre, J. Gaubicher, P. Moreau, P. Soudan, B. Lestriez and D. Guyomard, J. Mater. Chem., 2011, 21, 6201-6208.).

In order to overcome mechanical cracking or fracture during cycling, it is necessary to reduce the particle size of Si, while the potential of nano Si to be fully adopted in commercial entities is largely sacrificed consequential of reduced tap density and low areal mass loading. Incorporating carbonaceous species into Si offers an alternative solution to suppress the detrimental effects of volumetric variation and improve the electrical continuity. However, conformal carbon coatings on Si would rapture readily upon swelling and re-expose it to side-product deposition (H. Wu, G. Chan, J. W. Choi, I. Ryu, Y. Yao, M. T. McDowell, S. W. Lee, A. Jackson, Y. Yang, L. Hu and Y. Cui, Nat. Nanotech., 2012, 7, 310-315.). Conductive polymers and carbon nanostructures, in particular graphene and its derivatives, provide flexible backbones to better accommodate the Li ion insertion/extraction stress when introduced into Si anode. Nevertheless, the inherently high surface energy of Si particles is conducive to electrochemical sintering, leaving the long-term cycling stability and inferior coulombic efficiency unresolved (referring to D. M. Piper, T. A. Yersak, S.-B. Son, S. C. Kim, C. S. Kang, K. H. Oh, C. Ban, A. C. Dillon and S.-H. Lee, Adv. Energy Mater., 2013, 3, 697-702.) As the material loading increases, the primary Si particles located near the center of large aggregates becomes separated from conductive components, leading to further deterioration of overall performance. Thus until now, there is still a lack of Si anode development and comprehensive cell designs that are compatible with commercial configurations and high-throughput manufacturing protocols.

### SUMMARY OF THE INVENTION

This invention describes a new form of high-performance Si composite anode constructed from carbon gel sheathed Si particles and graphene building blocks by a facile and scalable synthetic approach. The Si particles are encapsulated by a uniform carbonized polymer gel and enveloped in a graphene matrix, which affords a combination of superior rate capability, cycling life and improved volumetric capacity.

The present invention provides a silicon and graphene-incorporated rechargeable Li-ion batteries with enhanced energy delivery and cycling life comprising a high-perforrnance Si composite anode, a cathode film and electrolyte.; the anode and cathode are immersed in or partially immersed in the electrolyte; wherein the anode is formed of a mixture of carbon coated Sicomposited with graphene by using a polymer binder as a binder , in which conductive additive is added if necessary.

The method for forming Si/graphene-based anode comprises the steps of mixing the carbon coated Si with graphene; adding a polymer binder and a conductive additive which is selected from one of carbon black, carbon nanotubes (CNTs) or carbon nanofibers (CNFs) if, necessary; depositing the mixture onto current collectors by tape casting, spin coating, dip coating or lamination etc.

Furthermore, the carbon coated Si with graphene composite is formed by a method comprising the steps of: forming polymer sheathed core-shell structure by dispersing Si particles in an aqueous or organic solution containing a polymer, or mixing the Si particle with monomers followed by in-situ polymerization so as to form polymer coated Si particles; carbonizing polymer coated Si particles into carbon encapsulated Si composites; and mechanical agitating particles with graphene nanoplatelets so as to form the carbon coated Si and graphene composite.

### BRIEF DESCRIPTION OF THE DRAWINGS

FIG. 1 is a schematic view showing the carbon gel sheathed Si particles of the present invention that are embedded between flexible graphene sheets, resulting in continuous conducting pathways.

FIG. 2(a) is a TEM images of carbonized Si particles, a high magnification image of a highlighted region showing approximately 10 nm thick amorphous carbon coating and the lattice fringe of the Si (111) plane,

FIG. 2(b) is an SEM image showing carbon coated Si particles distributed on graphene sheets uniformly.

FIGS. 3(a) and 3(b) show the electrochemical testing results of phloroglucinol-formaldehyde coated Si (PF-Si)/graphene composite anodes, where FIG. 3(a) shows the relation between specific delithiation capacity and coulombic efficiency of PF-Si/graphene composite anodes at various current densities ranging from 0.25 to 2.1 A/g; and FIG. 3(b) shows the relation between long-term cycling test of PF-Si/graphene composite anode at a constant current density of 2.1 A/g.

FIGS. 4(a) and (b) show the electrochemical testing results of pouch cells comprising NMC cathode and PF-Si/graphene composite anode. FIG. 4(a) shows the galvanostatic charge/discharge profiles at a constant rate of 0.5 C between 3-4.1 V; a 3.8×5.9 cm electrode pair attained a cell capacity of 26 mAh; and FIG. 4(b) shows the capacity retention and corresponding anode capacity during galvanostatic charge/discharge cycling.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

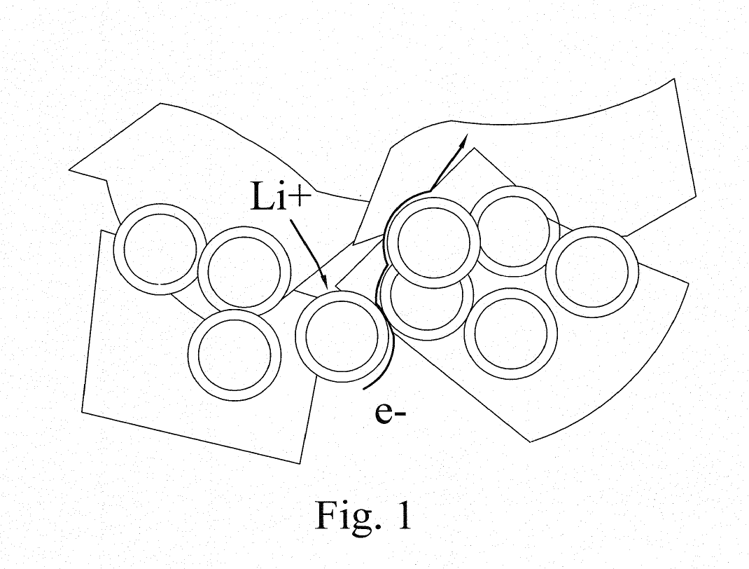

A silicon and graphene-incorporated rechargeable Li-ion battery with enhanced energy delivery and cycling life includes a new form of high-performance Si composite anode, a cathode film and electrolyte. The anode and cathode are immersed in or partially immersed in the electrolyte. The high-performance Si composite anode is constructed from carbon gel sheathed Si particles and graphene building blocks by a facile and scalable synthetic approach. The Si particles are encapsulated by a uniform carbonized polymer gel and enveloped in a graphene matrix, as shown in FIG. 1, which affords a combination of superior rate capability, cycling life and improved volumetric capacity.

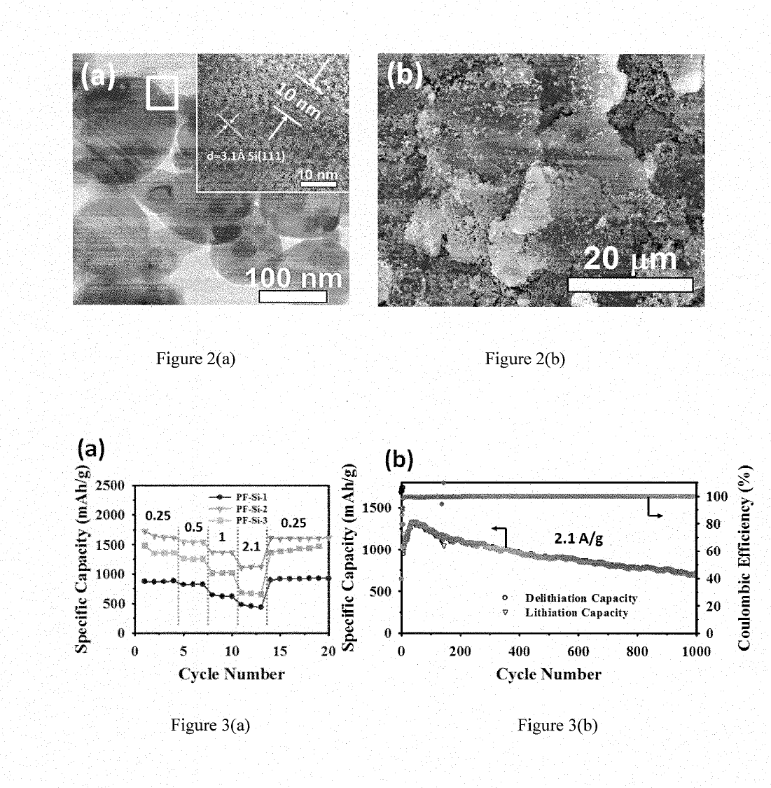

Si particles are dispersed in an aqueous or organic e.g. ethanol, acetone, isopropanol, dimethylformamide and N-methyl-2-pyrrolidone solution containing a polymer e.g. polymethyl methacrylate (PMMA), polyvinyl chloride (PVC), polyethylene oxide (PEO), poly(propylene oxide) (PPO), polyvinylpyrrolidone (PVP), polyvinyl alcohol (PVA) and poly(acrylonitrile) (PAN). Or else the Si particles are mixed with monomers e.g. acrylate, ethylene oxide, resorcinol-formaldehyde (RF) gel and phloroglucinol-formaldehyde (PF) gel followed by in-situ polymerization to form polymer sheathed core-shell structures. The polymer coated Si particles are then carbonized into carbon encapsulated Si composites, as shown in FIG. 2(a). Formulation of the carbon coated Si with graphene is accomplished by mechanical agitation of the particles with graphene nanoplatelets, as shown in FIG. 2(b).

To fabricate a Si/graphene-based anode, the carbon coated Si/graphene composite is mixed with a polymer binder, and an addition of conductive additive such as carbon black, carbon nanotubes (CNTs) or carbon nanofibers (CNFs) if necessary. The mixture is deposited onto current collectors by tape casting, spin coating, dip coating or lamination etc. The binders include at least one of poly(vinylidene fluoride) (PVDF), copolymers of PVDF e.g. poly(vinylidene fluoride-co-hexa fluoropropylene) (PVDF-HFP), PVC, PVA, polyethylene (PE), polypropylene (PP), ethylene vinyl acetate, and celluloses e.g. methyl cellulose, carboxymethyl cellulose, ethyl cellulose, butyl cellulose cellulose acetate and cellulose nitrate.

The cathode film is a blend of a conductive additive e.g. graphite flakes, CNTs, CNFs or g aphene, a polymer binder and an active material such as intercalation materials e.g. LiCoO₂, LiMn₂O₄, lithium nickel oxide (LiNiO₂), lithium iron phosphate (LiFePO₄), manganese oxide (MnO₂), vanadium oxide (V₂O₅) and molybdenum oxide (MoO₃), or sulfur, or active organics e.g. electrically conducting polymers and, oxocarbon salts.

The electrolyte is a non-aqueous solution containing one or a few types of carbonates e.g. ethylene carbonate (EC), propylene carbonate (PC), dimethyl carbonate (DMC) and diethyl carbonate (DEC) etc., and a lithium salt e.g. LiPF , LiClO₄, LiTFSI, LiAlO₂ and LiBF₄. Alternatively, the electrolyte can be a gel or solid film, which also acts as a separator. It consists of a polymer host e.g. PVDF, PVDF-HFP, PEO, PAN, and PMMA or an ionic liquid e.g. PYR₁₄FSI, [BMIM]Cl and [EMIM]Cl, a lithium salt, and an optional plasticizer e.g. inorganic nanoparticles (SiO₂, Al₂O₃ and MgO etc.), EC and PC to strengthen the ionic conductivity.

In the following. one example about the application will be described herein with reference the related drawings.

In one example, carbon encapsulated Si particles are fabricated by carbonizing 100 nm-sized Si powders bonded to phloroglucinol-formaldehyde (PF) gel. The PF gel is carbonized in an inert atmosphere at 800° C., and tuning of the Si content is achieved by varying the weight ratio of Si and PF polymer precursors.

Half-cell charge/discharge tests are done using a CR2032-type coin cell. Metallic lithium is used as the counter electrode. The working electrode is fabricated by firstly pasting a mixture of PF coated Si/graphene composite and polyacrylic acid (PAA) onto cupper foil. The typical mass loading level is about 1 mg per cm² area of the electrode. The electrode is dried at 90° C. for 12 h under vacuum before being assembled into a coin cell in an Ar-filled glovebox. The electrolyte solution is 1 M LiPF₆/ethylene carbonate (EC)/dimethyl carbonate (DMC) (1:1 by volume). A microporous glass-fiber membrane (Whatman) was used as the separator.

The composite anode attains a reversible capacity of approximately 1600 mAh/g based on the mass of PF-Si particles, when being tested at a constant current density of 0.5 A/g. The reversible capacity of PF-Si composite stabilizes at 1100 mAh/g when increasing the rate from 0.25 A/g to 2.1 A/g, as shown in FIG. 3(a). At a constant rate of 2.1 A/g, a single charge/discharge cycle takes only 15 minutes, while the capacity fade is as low as ca. 0.04% per cycle up to 1000 cycles on average, as shown in FIG. 3(b).

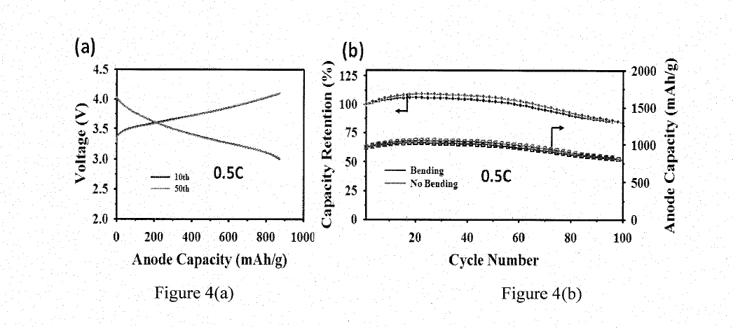

To assemble a full cell, the separator is placed on the anode, and a lithium nickel manganese cobalt oxide (NMC) cathode is stacked on top. The full cell is sealed inside an aluminum laminated pouch with metal current collectors extending out The electrolyte solution containing 1 M LiPF₆/ethylene carbonate (EC)/dimethyl carbonate (DMC) (1:1 by volume) is injected into the pouch before sealing. When cycled between −3 and 4.1 V at a constant rate of 0.5 C, the cell reversibly charged and discharged with stable capacity retention close to its designed cell capacity of 1.2 mAh/cm, showing a potential plateau at around 3.5 V, as shown in FIG. 4(a). After 100 cycles, the cell maintained 85% of its initial capacity as shown in FIG. 4(b), while delivering a high gravimetric energy density of 420 Wh/kg based upon the total mass of electrode materials. The corresponding anode capacity was ca. 950 mAh/g at maximum.

The present invention affords a combination of superior rate capability, cycling life and improved volumetric capacity attributed to (1) the intimate electrical contact consolidated by the carbonaceous networks; (2) the elastic carbon coating and graphene sheets that effectively restrain structural damage in contrast to rigid carbon shells and conventional additives; and (3) a high packing density and sustained structural integrity enabled by the compact graphitic domains. Proceeded by tape casting and coupling with a formulated lithium metal oxide cathode, the Si composite anode displays adequate performance at practically viable high mass loading in full cell formats.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A silicon and graphene-incorporated rechargeable Li-ion battery with enhanced energy delivery and cycling life by using a silicon and graphene based anode, comprising a high-performance Si composite anode, a cathode film and electrolyte; the anode and the cathode film are immersed in or partially immersed in the electrolyte; wherein the anode is formed of a mixture of carbon coated Si and graphene, formulated using a polymer binder.

2. The silicon and graphene-incorporated rechargeable Li-ion batteries with enhanced energy delivery and cycling life by using a silicon and graphene based anode as claim in claim 1, wherein the mixture forming the anode is added with a conductive additive which is selected from one of carbon black, carbon nanotubes (CNTs) or carbon nanofibers (CNFs); the mixture is deposited onto current collectors by tape casting, spin coating, dip coating or lamination etc.

3. The silicon and graphene-incorporated rechargeable Li-ion batter with enhanced energy delivery and cycling life by using a silicon and graphene based anode as claimed in claim 1, wherein the cathode film is a blend of a conductive additive, a polymer binder and an active material.

4. The silicon and graphene-incorporated rechargeable Li-ion batteries with enhanced energy delivery and cycling life by using a silicon and graphene based anode as claimed in claim 3, whrein the conductive additive is selected from at least one of graphite flakes, CNTs, CNFs or graphene.

5. The silicon and graphene-incorporated rechargeable Li-ion batteries with enhanced energy delivery and cycling life by using silicon and graphene based anode as claimed in claim 3, wherein the active cathode material is an intercalation materials.

6. The silicon and graphene-incorporated rechargeable Li-ion batteries with enhanced energy delivery and cycling life by using silicon and graphene based anode as claimed in claim 5, wherein the intercalation material is at least one of LiCoO₂, LiMn₂O₄, lithium nickel oxide (LiNiO₂), lithium iron phosphate (LiFePO₄), manganese oxide (MnO₂), vanadium oxide (V₂O₅) and molybdenum oxide (MoO₃), or sulfur, or active organics.

7. The silicon and graphene-incorporated rechargeable Li-ion batteries with enhanced energy delivery and cycling life by using silicon and graphene based anode as claimed in claim 6, wherein the active organics is one of electrically conducting polymers and oxocarbon salts.

8. The silicon and graphene-incorporated rechargeable Li-ion batteries with enhanced energy delivery and cycling life by using a silicon and graphene based anode as claimed in claim 1, wherein the electrolyte is a non-aqueous solution containing one or a few types of carbonates and a lithium salt.

9. The silicon and graphene-incorporated rechargeable Li-ion batteries with enhanced energy delivery and cycling life by using a silicon and graphene based anode as claimed in claim 8, wherein the carbonate is selected from ethylene carbonate (EC), propylene carbonate (PC), dimethyl carbonate (DMC) and diethyl carbonate (DEC) and the lithium salt is selected from LiPF₆, LiClO₄, LiTFSI, LiAlO₂ and LiBF₄.

10. The silicon and graphene-incorporated rechargeable Li-ion batteries with enhanced energy delivery and cycling life by using a silicon and graphene based anode as claimed in claim 1, wherein the electrolyte is a gel or solid film, which also acts as a separator.

11. The silicon and graphene-incorporated rechargeable Li-ion batteries with enhanced energy delivery and cycling life by using a silicon and graphene based anode as claimed in claim 10, wherein the separator consists of a polymer host or ionic liquid, and a lithium salt to strengthen the ionic conductivity.

12. The silicon and graphene-incorporated rechargeable Li-ion batteries with enhanced energy delivery and cycling life by using a silicon and graphene based anode as claimed in claim 11, wherein the polymer host is selected from one of PVDF, PVDF-HFP, PEO, PAN, and PMMA; and the ionic liquid is selected from PYR₁₄FSI, [BMIM]Cl and [EMIM]Cl.

13. The silicon and graphene-incorporated rechargeable Li-ion batteries with enhanced energy delivery and cycling life by using a silicon and graphene based anode as claimed in claim 11, wherein the separator further comprises a plasticizer selected from inorganic nanoparticles (SiO₂, Al₂O₃ and MgO etc.), EC and PC.

14. A method for forming Si/graphene-based anode comprises the steps
mixing the carbon coated Si and graphene composite with a polymer binder;
depositing the mixture onto current collectors by tape casting, coating, dip coating or lamination.

15. The method of claim 14, further comprising the steps of after mixing carbon and the graphene, adding conductive additive to the mixture, the conductive additive being selected from one of carbon black, carbon nanotubes (CNTs) and carbon nanofibers (CNFs).

16. The method of claim 14, wherein the binder includes at least one of poly(vinylidene fluoride) (PVDF), poly(vinylidene fluoride-co-hexa fluoropropylene) (PVDF-HFP), PVC, PVA, polyethylene (PE), polypropylene (PP), ethylene vinyl acetate, and celluloses which is selected from methyl cellulose, carboxymethyl cellulose, ethyl cellulose, cellulose cellulose acetate and cellulose nitrate.

17. The method claim 14, wherein the composite of carbon coated Si and graphene is formed by a method comprising the steps of
forming polymer sheathed core-shell structure by dispersing Si particles in an aqueous or organic solution containing a polymer, or mixing the Si particle with monomers followed by in-situ polymerization so as to form polymer coated Si particles;
carbonizing polymer coated Si particles into carbon encapsulated Si composites; and
mechanically agitating particles with graphene nanoplatelets so as to form the carbon coated Si and graphene composite.

18. The method of claim 16, wherein the organic solution comprises at least one of ethanol, acetone, isopropanol, dimethylfomamide and N-methyl-2-pyrrolidone.

19. The method of clam 16, wherein the polymer is selected from one of polymethyl methacrylate (PMMA), polyvinyl chloride (PVC), polyethylene oxide (PEO), polypropylene oxide) (PPO), polyvinylpyrrolidone (PVP), polyvinyl alcohol (PVA) and poly(acrylonitrile) (PAN).

20. The method of claim 16, wherein the monomers are selected from at least one of acrylate, ethylene oxide, resorcinol-formaldehyde (RF) gel and phloroglucinol-formaldehyde (PF) gel.
